(19) United States
(12) Patent Application Publication
(10) Pub. No.: US 2026/0264788 A1
(43) Pub. Date: Sep. 10, 2026

(54) WHEEL HUB WITH ANTI-THEFT MEANS

(71) Applicant: 2LOCK GMBH, Nittendorf (DE)

(72) Inventor: Simon Bäuml, Eilsbrunn (DE)

(21) Appl. No.: 19/159,438

(22) PCT Filed: Mar. 6, 2024
(86) PCT No.: PCT/DE2024/100181

§ 371 Date: Aug. 25, 2025

(30) Foreign Application Priority Data
Mar. 9, 2023 (DE) 10 2023 105 853.3

(51) Int. Cl. B62H 5/00; B60B 27/00; B60B 27/02; B62K 25/02

(52) U.S. Cl. CPC B62H 5/001; B60B 27/0047; B60B 27/026; B62K 25/02; B60B 2900/3318

(57) ABSTRACT

The invention relates to a wheel hub for clamping into a wheel fork, which wheel hub has a wheel hub-axle and a hub housing (10, 11, 12) held on the wheel hub-axle. The wheel hub-axle is designed as a hollow shaft (2), whereby the wheel hub also has a plug-in axle (1) which can be inserted through the hollow shaft (2) in order to clamp the wheel hub into a wheel fork so that it can then be fixed at its respective ends to the fork ends. The wheel hub is characterized in that it has a locking lug (5; 5′) that is movably held in the wheel hub housing and can be brought into a locking position for locking the plug-in axle (1) in the hollow shaft (2), in which position the locking lug (5; 5′) can be inserted into a recess (1′; 1″) provided on the thru-axle. This means that the wheel hub—and thus the wheel—is secured against theft in the wheel fork, as the thru-axle can no longer be easily pulled out of the wheel hub.

The present invention relates to a wheel hub, as well as a wheel with the wheel hub installed therein, or a vehicle with the wheel mounted therein. The wheel hub is particularly suitable for use in two-wheeled vehicles such as bicycles, pedelecs, mopeds, motorcycles, but also for wheels in general, such as those used in tricycles or wheelchairs. In the following, these mobile vehicles relevant to the present invention are all summarized under the term “vehicle.”

Conventionally, a wheel is clamped into a wheel fork as the front wheel of a bicycle or two-wheeler. In the prior art, there are various technical implementation options: for example, there are wheel hubs in which external threads protrude from the respective side surfaces of the cylindrical hub housing. These can be inserted into a respective U-profile of a fork end and then fixed in place by means of a screw nut. It is also known that the hub housing sits on a hollow shaft coaxial to the axis of rotation of the wheel, through which a thru-axle can be pushed. While there is a screw head at one end of the thru-axle, an external thread is provided at the opposite end of the thru-axle. To secure the wheel in the wheel fork, the radially protruding screw head holds the thru-axle in one fork leg, while a screw nut is screwed onto the opposite end to finally secure the wheel in the fork. Finally, there are quick-release fastener designs in which the external thread of the plug-in bolt is provided with a bracket on the screw nut, which is flipped by hand to finally tighten the wheel in the fork.

Theft protection remains a relevant issue for vehicles. The state of the art includes cable locks, U-locks, and folding locks, which can be used, for example, to “lock” a wheel installed in a vehicle, i.e., a lock is passed through the space between the wheel spokes and then locked. This prevents the wheel from turning and, at the very least, prevents the vehicle from being pushed away. If such a lock is now attached to another object, the wheel cannot be taken away either; however, if the wheel is removed from the vehicle's wheel fork, the vehicle can be taken away. Ultimately, only the wheel remains in place, but not the vehicle.

In the prior art, it is known from CN 2 04 978 965 U to design the thru-axle intended for clamping the wheel hub as a hollow shaft into which a bolt lock can be inserted. This bolt lock has a locking bolt that can be moved radially to the bolt axis by means of a key, through a hole in the thru-axle and further through a concentrically arranged hole in the wheel hub shell. This prevents the wheel hub from rotating and locks the wheel in a rotationally rigid manner. In contrast, US. Pat. No. 6,425,642 shows a locking mechanism for preventing a wheel from being removed from a fork bridge. The locking mechanism has a thru-axle, onto one end of which a lock body is to be pushed, the locking bolt of which, when the key is turned, engages in a groove on the thru-axle and locks the thru-axle. Finally, DE 10 2009 033 475 A1 discloses a hub lock in which a bolt that can be moved within the hub housing can be inserted into a ring gear held on the thru-axle to block rotation of the wheel.

The present invention addresses the above problem of removing the wheel from the vehicle and presents a wheel hub that significantly hinders unauthorized removal of the wheel. This also improves the theft protection of the vehicle itself, because the wheel can no longer be easily detached from the vehicle in order to remove the vehicle with the wheel locked in place.

The wheel hub according to the invention is characterized by the features of claim 1. Advantageous embodiments are described in the subclaims. A combination of the wheel hub according to the invention and a vehicle with a wheel fork is mentioned in claim 11.

The core of the invention lies in providing a mechanism which, although it allows simple mounting of the wheel in a wheel fork with subsequent locking of the thru-axle in the wheel hub, only allows removal from the wheel fork with the aid of a type of key. A key is understood here to be a means by which a locking device on the thru-axle can be unlocked in its final position in the hollow shaft in order to pull the thru-axle out of the hollow shaft of the wheel hub.

According to the invention, the wheel hub has a wheel hub-axle and a hub housing held on the wheel hub-axle, wherein the wheel hub-axle is designed as a hollow shaft. Normally, the wheel hub-axle is rigidly clamped in a wheel fork, whereas when the wheel hub is clamped, the hub housing is held rotatably on the axle. The thru-axle of the wheel hub is inserted through the hollow shaft to clamp the wheel hub in a wheel fork and is then fixed at its respective ends to the fork ends. The plug-in axle is locked in the wheel hub—more precisely, in its hollow shaft'by a locking lug that is held movably in the wheel hub housing and engages in a recess provided on the plug-in axle for locking purposes. The locking lug can be moved between two end positions, one of which defines a locked position of the thru-axle in the hollow shaft, while the other defines an unlocked position, at which point the thru-axle can be pulled out of the hollow shaft.

The locking lug is housed in the hub housing in a tamper-proof manner. In other words, the hub housing is sealed on all sides and does not allow access to its interior. The space between the outer circumference of the hollow shaft and the cylinder jacket of the hub housing provides space for housing the locking lug. In order to allow the locking lug to access the plug-in axle, the hollow shaft has a radial opening through which or into which the locking lug can be moved to reach its respective end positions.

An electric motor, which is also held in the hub housing, is advantageously provided for moving the locking lug. For this purpose, a component carrier is provided in the hub housing, which is rotationally rigidly mounted on the hollow shaft.

According to an advantageous embodiment, the locking lug can also be preloaded by means of a spring, which is capable of pressing the locking lug into its final locking position. The spring is preloaded by the movement of the locking lug into the unlocking position by means of motor action.

### Embodiment 1

According to one embodiment of the invention, the recess on the plug-in axle is provided as a radially circumferential depression or groove in the form of a reduction in the outer diameter of the plug-in axle over a predetermined length. When the thru-axle is fully inserted into the hollow shaft, the movable locking lug is provided locally and functionally opposite this recess section on the component carrier, which can be moved between its two end positions by means of a motor. In one “retracted” end position, which defines an unlocked or released state of the quick-release fastener, the locking lug does not protrude into the recess or milled-out section. The plug-in axle is then “released” and can be pulled out of the hollow channel of the hollow shaft. In the other, second end position, which defines a locked state of the plug-in axle, the locking nose is moved from its unlocked position by motor power into or through the radial opening in the hollow shaft in order to reach the locking position.

Two alternatives are possible in this regard: According to a first alternative, the motor moves the locking lug into a position in which it protrudes into the aforementioned recess on the plug-in axle. According to the second, more advantageous alternative, the motor merely moves the locking lug into a “release position” in which the locking lug does not necessarily protrude into the recess. Only the spring provided for this purpose can press the locking lug into the recess in this release position. On the other hand, activating the motor in the opposite direction moves the locking lug out of the recess, thereby unlocking the thru-axle and thus the wheel, allowing the thru-axle to be pulled out of the hollow channel and thus the fork ends, and the wheel to be removed from the fork.

By activating the motor associated with the locking lug, the thru-axle can thus be locked in the hollow channel and thus between the fork ends in a theft-proof manner. Insofar as the fork ends have a circumferentially closed bore for inserting the thru-axle, the wheel can no longer be removed from the vehicle.

### Embodiment 2

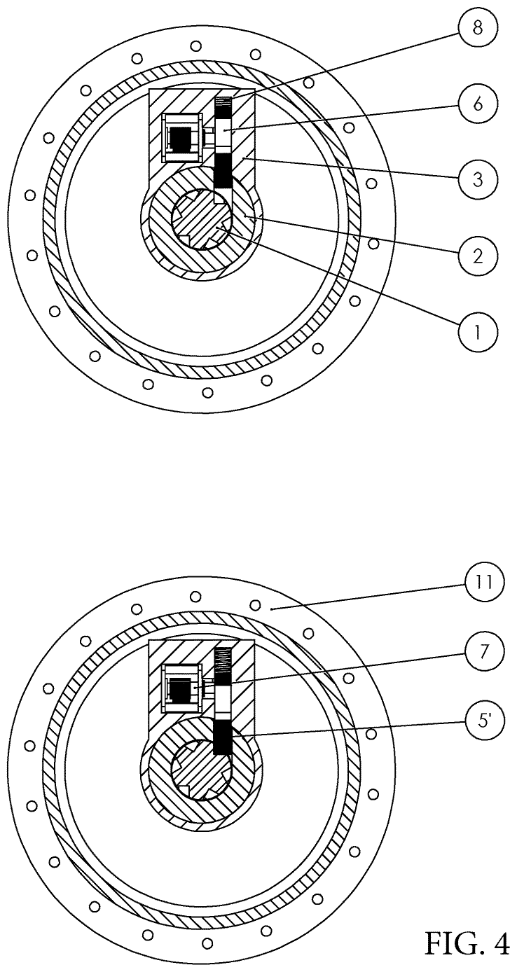

According to another embodiment of the invention, the aforementioned recess is formed by at least one pocket provided by a radial wedge-shaped incision on the outer circumference of the thru-axle in the longitudinal axis direction. Complementary to this pocket, the locking lug is advantageously offset relative to the radius of the hollow shaft—i.e., offset parallel to the radius of the thru-axle—so that the wedge-shaped notch for the locking lug forms a kind of “rotating blade” as soon as the thru-axle is turned in the appropriate direction. As a result, the plug-in axle remains rotatable in one of its two directions of rotation even in a situation where the locking lug is in the locked position, because when the plug-in axle is rotated, a tangential force acts on the locking lug, with which the locking lug can be lifted in the direction of its unlocked position by the rotation of the plug-in axle; whereas the other direction of rotation is blocked (see details for illustration in embodiment 2 according to FIG. 4). Then the hollow shaft opening in which or through which the locking lug can be moved to reach its respective end positions is also not arranged radially but is equally offset parallel to the radius of the hollow shaft.

Here, too, two alternatives are possible: According to a first alternative, the motor moves the locking lug into a position in which it protrudes into the aforementioned pocket on the plug-in axle. According to the second, more advantageous alternative, the motor merely moves the locking lug into a “release position” in which the locking lug does not necessarily protrude into the pocket. Only the spring provided for this purpose can press the locking lug into the pocket in this release position. On the other hand, activating the motor in the opposite direction moves the locking lug out of the pocket, thereby unlocking the thru-axle and thus the wheel, allowing the thru-axle to be pulled out of the hollow channel and thus the fork ends, and the wheel to be removed from the fork.

The above embodiment is particularly and advantageously suitable for a system in which one end of the fork has an internal thread into which the external thread of the thru-axle can be screwed. This allows the thru-axle to be easily screwed into the thread to secure the wheel in the fork, whereas opening in the opposite direction of rotation to unscrew the thru-axle from the fork end is prevented, insofar as the locking lug protrudes into the pocket of the thru-axle.

If, according to a further advantageous embodiment, several of these pockets are provided, distributed over the outer circumference of the thru-axle, a ratchet effect results: when the thru-axle is turned (for example, to tighten it in the fork ends), the locking lug is lifted and moved by the radial force component from a flat—lying position in the respective pocket against the spring force in the direction of the unlocking position, whereby the locking lug slides into the next pocket when the thru-axle is turned further due to the spring preload.

This ratchet mechanism results in an effect on the locking lug similar to a paddle wheel when the thru-axle is turned one full revolution.

The rotational movement of the plug-in axle in the opposite direction of rotation is blocked because a force acts on the locking lug in this direction of rotation, which has only a single force direction perpendicular to the displacement direction of the locking lug. This direction of rotation is therefore only possible when the locking lug has been moved from its locked position to the unlocked position by means of the motor.

Further details concerning both of the above embodiments with groove and pocket:

According to an advantageous embodiment of the locking lug method, the associated motor has a rotating shaft on which an eccentric bearing with a round outer cylinder shape is fixed in a rotationally rigid manner to the rotating shaft. The bore of the bearing for receiving the rotary shaft is arranged eccentrically in the cylinder. When the rotary shaft of the motor is rotated, the eccentric bearing describes a circular motion. Complementary to the eccentric bearing, the locking nose has a bore—for example, a through bore or a blind hole—in which the eccentric bearing is held. When the motor's rotating shaft turns, the eccentric bearing held eccentrically on it turns with it, allowing the locking nose to be moved into different positions. In an advantageous embodiment, the bore in the locking nose is dimensioned larger than the outer circumference of the eccentric bearing and the locking nose is also held in a linear slide guide so that the rotational movement of the motor shaft results in a linear displacement of the locking nose, with which the locking nose can be moved into its two positions described above.

According to a further advantageous embodiment, the bore in the locking nose is designed as a slot or approximately in the shape of a slot, the longitudinal extension of which is perpendicular to the direction of displacement of the locking nose. In an embodiment of the locking lug with spring preload, which acts in the direction of movement in which the locking lug moves into its locking position, the motor can only pull the locking lug out of the milled recess or pocket of the plug-in axle against the spring force—thereby simultaneously preloading the spring; However, the locking lug is not pushed completely into the milled recess by the motor force. While the motor moves the locking lug into a “release position,” it is only the spring force that causes the locking lug to move completely into the recess or pocket. If the motor turns the eccentric bearing into the aforementioned “release position” for locking, the eccentric bearing will at most move into the center of the elongated hole. In other words, the motor can only “release” the locking lug in the slotted hole to the extent that the spring first pushes the locking lug into the recess with its spring force. This has the advantage that the motor is not damaged if the thru-axle is not fully inserted into the fork and the hollow shaft and the locking lug therefore cannot fit precisely into the milled recess. In this case, the locking lug with its preloaded spring sits on the circumference of the thru-axle with a larger outer diameter. Only when the thru-axle is fully inserted into the hub hollow shaft does the locking lug then enter the aforementioned recess or pocket due to the spring force.

In general, the motor can be controlled via a remote control and remote control via a control chip, which components are provided on the component carrier in the hub housing. A control circuit is provided to detect the two extreme positions of the eccentric, in which the locking lug is either in the unlocked position or in the locked position, or the “release position”: As soon as the locking lug has reached the fully unlocked position by rotating the motor shaft, the current requirement and thus the power output of the motor increases to the extent that the motor is unable to move the locking lug any further, which in turn is detected by the control chip. Reaching the maximum current flow defines the reaching of the unlocked position of the locking lug. Reaching this position can be supported by a mechanical stop, which the locking lug hits when it reaches its unlocked position and which prevents further movement by the motor of the locking lug in this direction of movement. A time phase is then stored on the memory chip, which is required to control the rotation of the motor shaft from this unlocking position so that the opposite locking position—or rather the designated “release position” of the locking lug—is reached.

Power for the electrically operated components of the wheel hub can be supplied by a battery housed in the wheel hub. This can also be powered by a wheel hub dynamo housed in the wheel hub. Alternatively, according to an advantageous embodiment, the power supply is provided by a battery provided on the vehicle.

The invention is explained below with reference to both embodiments, which are each shown in the accompanying drawings.

The drawings show

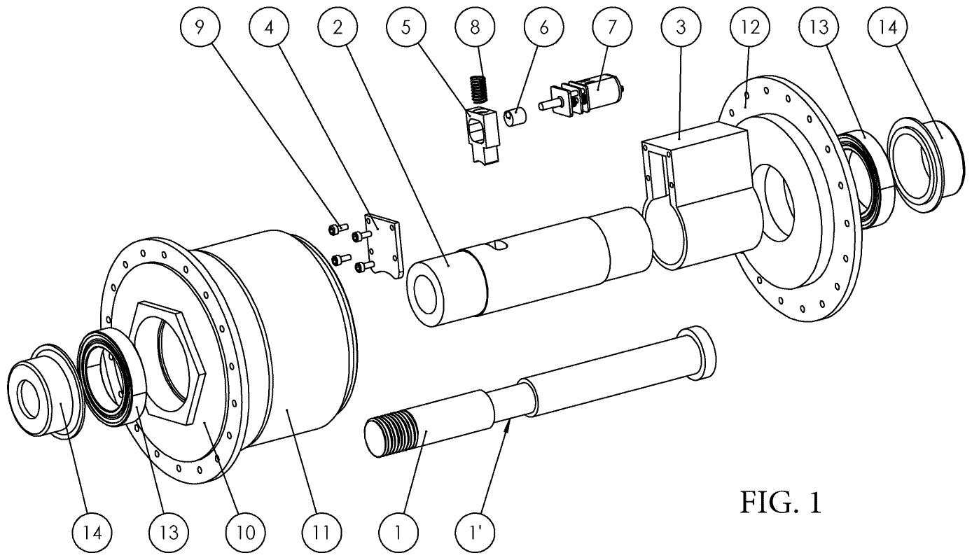

FIG. 1 an exploded side view of the wheel hub according to the invention with a circumferential groove;

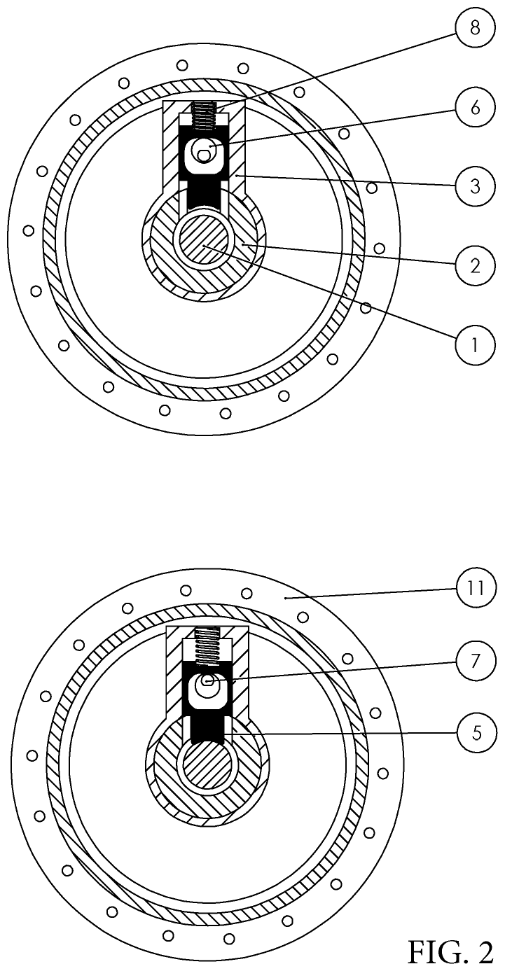

FIG. 2 two sectional views of the embodiment of FIG. 1, each with a locking lug in the unlocked position and a locking lug in the locked position;

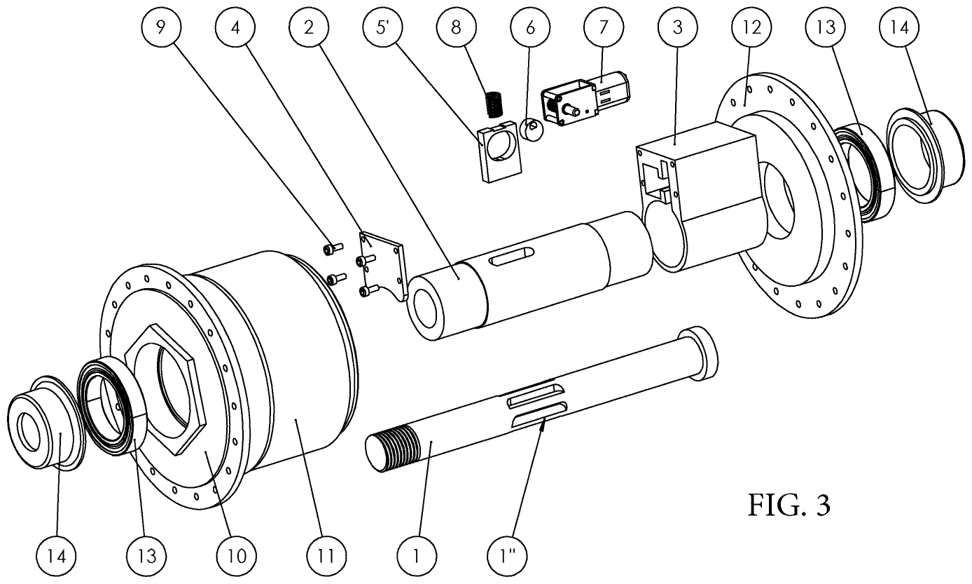

FIG. 3 shows an exploded side view of the wheel hub according to the invention in an alternative embodiment to FIG. 1 with a ratchet mechanism;

FIG. 4 shows two sectional views of the embodiment of FIG. 3, each with a locking lug in the unlocked position and a locking lug in the locked position;

FIG. 1 shows an embodiment of the wheel hub according to the invention with further details, as presented above as “embodiment 1”. The wheel hub has a closed cylindrical housing with two side surfaces 10, 12 closing the housing, each of which has holes on the outer circumference for fixing spokes therein. The side surfaces are firmly connected by a cylinder shell 11 of the hub housing, thereby creating an interior space of the hub housing.

Coaxial to the axis of the hub housing is a hollow shaft 2 of the wheel hub, which, after the wheel is mounted on the vehicle, is held rigidly on both sides at the fork ends of the vehicle. To enable the wheel, i.e. the spoked wheel rim with the hub housing, to rotate on the hollow shaft 2, a respective ball bearing 13 is located at both ends of the hollow shaft 2, on which a respective side surface of the hub housing is held. The hub housing is further closed by spacer bushings 14 provided on both sides of the respective side surface, which have only one opening for passing through a thru-axle 1. Except for these openings, the hub housing is thus closed and not accessible from the outside.

To secure the wheel, i.e. the wheel hub, to the struts of a wheel fork (not shown), a thru-axle 1 is provided, which is to be pushed through the aforementioned openings in the spacer bushings, as well as through the side surfaces of the hub housing and the hollow shaft 2. The length of the thru-axle 1 is chosen so that it can protrude beyond both side surfaces 10, 12 of the hub housing. In the embodiment shown, the thru-axle has an Allen screw head at one end with a screw collar protruding from the rest of the outer diameter of the thru-axle, whereas the thru-axle 1 has an external thread at the other end. To mount the wheel hub, the thru-axle 1 is inserted through the hollow shaft 2 with the external thread facing forward, so that the thru-axle can then be screwed in using an Allen wrench by screwing the external thread into a complementary internal thread on a fork leg. A polygonal screw head can also be used instead of the Allen head.

A component carrier 3 is mounted rotationally rigid on the hollow shaft 2, to which a motor 7 is attached. The motor has a rotating shaft on which an eccentric 6 is mounted rotationally fixed with the rotating shaft. The eccentric is a solid cylinder with a bore offset from its longitudinal axis, the inner diameter of which corresponds to the outer diameter of the rotating shaft. When the motor's rotating shaft is set in motion, the outer circumference of the eccentric cylinder describes a circular motion.

Reference number 5 indicates a locking lug with a slotted hole in its upper part. The eccentric 6 is mounted in this slotted hole. The orientation of the longitudinal axis of the elongated hole is chosen so that the locking lug 5 performs a linear movement when the eccentric 6 rotates—namely, in a radial direction from the interior of the hub housing to the plug-in axle and back. The lateral limitation to this linear movement of the locking lug 5 is provided by an opening in the hollow shaft 2. This opening is configured in such a way that only one degree of linear freedom remains for movement of the locking lug 5. The rotation of the motor shaft 7 allows two extreme positions of the locking lug to be defined: one forms the unlocking position of the locking lug when the locking lug 5 is fully raised, while the other extreme position means a “release position” for the lock. This release position means that the locking lug 5 cannot enter the circumferential groove 1′ with one end solely by means of the motor force. This final locking position of the locking nose 5 with one end in the circumferential groove 1′ is achieved exclusively by the relaxation of the preloaded spring 8. This spring exerts a force in the direction of the linear movement of the locking nose 5, with which one end, namely the lower end shown in the figure, enters the circumferential groove 1′. This ensures that when the plug-in axle 1 is not fully inserted, the locking nose 5 cannot be pressed against the outer surface of the plug-in axle with a larger outer diameter by means of motor power. The maximum movable movement of the locking nose 5 by the motor 7 and its eccentric 6 is therefore selected so that the locking nose 5 can only be moved into or within the hollow shaft 2 by means of motor force to such an extent that the locking nose 5 cannot touch the outer surface of the plug-in axle 1 with the maximum outer diameter (apart from the screw collar).

In the final locking position, which is the sum of the linear displacement achieved by motor power plus the displacement achieved by the spring force of spring 8, the locking lug 5 protrudes into the circumferential groove 1′ as a recess in the thru-axle when the thru-axle 1 is fully inserted. In this position, the thru-axle 1 can no longer be pulled out of the hollow shaft. In other words, even if the screw connection between the external thread of the plug-in axle 2 and the internal thread of the fork leg (not shown) is loosened, the wheel can no longer be removed from the fork leg(s).

In an additional advantageous manner, the circumferential groove 1′ on the plug-in axle 1 is dimensioned in its longitudinal direction such that it is at least as long as the length of the external thread of the plug-in axle plus the thickness (=dimension along the longitudinal axis of the plug-in axle) of the locking lug 5. In addition, the placement of the circumferential groove 1′ on the thru-axle 1 is then also chosen such that, in the locking position, the locking lug rests with one of its flanks against the shoulder of the circumferential groove that is further away from the external thread. This configuration has the following purpose: if an attempt is made to unscrew the plug-in axle with the wheel mounted and the locking lug in the locked position reaches the shoulder of the circumferential groove before the screw connection between the external thread of the plug-in axle and the internal thread of the fork leg is completely loosened, further rotation of the thru-axle would prevent the thru-axle from moving further in the longitudinal direction of its longitudinal axis, but the two fork legs would be spread apart due to a displacement between the external thread of the thru-axle and the internal thread on the fork leg. This would result in damage to the fork, which is to be prevented by the above configuration.

The component carrier 3, which serves as the motor housing, is covered by a plate 4 that is fixed to the component carrier by means of screw connection 9.

FIG. 2 shows the embodiment from FIG. 1 in assembled condition and in a sectional side view. In the upper illustration of this figure, the locking lug 5 is in the unlocked position. In other words, the locking lug 5 is raised, i.e., pulled out, from the circumferential groove 1′ of the plug-in axle to such an extent that the plug-in axle can move freely in the longitudinal direction and can be pulled out of the hollow shaft 2. This position of the locking lug 5 is achieved by the interaction of the rotating shaft of the motor 7 with the eccentric 6. The circular motion described by the eccentric 6 lifts the locking lug to its maximum raised position. This circular movement of the eccentric 6 is converted into a linear displacement movement of the locking lug 5 by the guide of the locking lug in the component carrier 3. Further guidance of the locking lug 5 is provided by the opening in the hollow shaft 2, in which the locking lug 5 is moved. In the unlocked position of the locking lug, the spring 8 is preloaded to its maximum. As can also be seen from this illustration, the position of the elongated hole in the locking lug is chosen so that its longitudinal axis is perpendicular to the linear direction of movement of the locking lug. Activating the motor with rotation of its rotating shaft now causes an eccentric movement of the eccentric 6 and thus a displacement movement of the locking nose 5; namely, once in the radial direction toward the circumferential groove 1′ and, opposite to this, in the radial direction of the plug-in shaft toward the outside.

In the lower illustration in FIG. 2, the locking lug 5 is in the locking position of the plug-in shaft 1. In other words, the locking lug protrudes into the circumferential groove 1′, thereby preventing the plug-in shaft from being pulled out of the hollow shaft. This position is due, on the one hand, to the rotation of the motor shaft, which, however, can only move the locking lug 5 into the aforementioned release position. The remaining movement of the locking lug into the circumferential groove is performed by the spring 8. This can be seen from the distance between the eccentric 6 and the shoulder of the elongated hole in this position of the locking lug.

In order to enable the locking lug 5 to fit properly on the plug-in axle 1 in the circumferential groove 1′, the locking lug is designed with the same curvature as the plug-in axle on its outer circumference at its contact surface with the plug-in axle.

FIG. 3 now shows the wheel hub according to the invention in the “embodiment 2” presented above. Identical reference numerals in this figure refer to the same components. The plug-in axle 1 now has indentations in the form of pockets 1″ distributed equidistantly over the outer circumference as recesses on the plug-in axle. Furthermore, the hollow shaft has an opening in which a locking lug 5′ can be moved, this opening being arranged parallel to the radius of the hollow shaft 2. This can be seen particularly well in the illustrations in FIG. 4. Incidentally, the opening is parallel to the longitudinal axis of the thru-axle in its longitudinal extension.

Each pocket 1″ is provided as a wedge-shaped notch on the plug-in axle at a specific length. This notch thus corresponds to the complementary shape of the rectangular end of the locking lug 5′ in its longitudinal extension in its locking position. The longitudinal extension of the locking lug 5′ is coaxial with the longitudinal axis of the plug-in shaft. In other words, the locking lug is fully engaged with the respective pocket in its longitudinal extension. As can also be seen in FIG. 3, the component carrier 3 has a guide for the locking nose 5′, which specifies a linear direction of movement for the locking nose 5′. A further guide for the locking nose 5′ is provided by the opening in the hollow shaft 2, in which the locking nose 5′ is held in a movable manner. In the unlocked position of the locking lug (see upper illustration in FIG. 4), the spring 8 is preloaded to its maximum. As can also be seen from this illustration, the position of the elongated hole in the locking lug is chosen so that its longitudinal axis is perpendicular to the linear direction of movement of the locking lug. Activation of the motor with rotation of its shaft causes an eccentric circular movement of the eccentric 6 and thus a displacement movement of the locking nose 5′, once in the direction toward the outer circumference of the plug-in shaft and once in the opposite direction away from the plug-in shaft.

The selected positioning of the locking lug guide with locking lug 5′ and pockets 1″ on the thru-axle results in a ratchet effect when the thru-axle 1′ is turned with the threaded connection closed (i.e., normally a clockwise turn) between the external thread of the thru-axle and the internal thread on the fork leg: After the locking lug 5′ enters one of the pockets 1″, the locking lug is lifted again by the bottom of the pocket as the plug-in axle continues to turn. This movement takes place over the entire distance against the spring force of spring 8, which is thus preloaded again. No force is exerted on the motor's rotating shaft. In other words, this rotational movement lifts the locking lug 5′ to such an extent that the bottom of the slotted hole cannot yet contact the eccentric. If the plug-in axle is now turned further in the clockwise closing direction, the locking lug 5′ is then pressed into the next pocket 1″ by the preload of spring 8, and so on.

If we consider the opposite rotation of the plug-in axle—i.e., in a counterclockwise opening direction to loosen the screw connection between the external thread of the plug-in axle and the internal thread on the fork leg—this movement is blocked as long as the locking lug 5′ is in its locked position and sits in a pocket. However, this situation inevitably occurs, even if it is not initially present, if the locking lug is not resting in a pocket. In this case, the plug-in axle can only be rotated a short distance, which cannot lead to the opening of the screw connection. Following this short rotational movement, the locking lug inevitably moves into the next pocket due to the spring force.

Unlocking process for both embodiments 1 and 2 above: The motor 7 can be controlled via a control chip with a remote control. The direction of rotation of the rotating shaft can be determined by means of the control, so that “unlocking” and “locking” can be selected using the remote control.

The power supply for the motor and, if applicable, the control chip is provided by an internal battery or by a battery or rechargeable battery cell provided on the vehicle.

### LIST OF REFERENCE MARKS

thru-axle 1
Recess (as a circumferential groove) 1′
ratchet bag 1″
hollow shaft 2
component carrier 3
plate 4
locking latch 5, 5′
eccentric 6
motor 7
spring 8
screw connection 9
side surface 10
cylinder shell of the hub housing 11
side surface 12
ball bearing 13
Spacer sleeve 14

1. A wheel hub for clamping into a fork, the wheel hub comprising a wheel hub-axle and a hub housing (10, 11, 12) held on the wheel hub-axle, wherein the wheel hub-axle is designed as a hollow shaft (2), and the wheel hub further comprises a thru-axle (1) which can be inserted through the hollow shaft (2) to clamp the wheel hub into a fork in order to subsequently fix it at its respective ends to the fork ends, characterized in that the wheel hub comprises a locking latch (5; 5′) movably held in the hub housing, which can be brought into a locking position to secure the thru-axle (1) in the hollow shaft (2), wherein the locking latch (5; 5′) engages in a recess (1′; 1″) provided on the thru-axle.

2. The wheel hub according to claim 1, characterized in that to lock the thru-axle in the hollow shaft, the locking latch (5; 5′) can be inserted through an opening in the hollow shaft into the recess (1′; 1″).

3. The wheel hub according to claim 1, characterized in that the thru-axle (1) has a quick-release lock at at least one of its ends.

4. The wheel hub according to claim 1, characterized in that the wheel hub comprises an internal actuation mechanism inside the hub housing (10, 11, 12) with an electrically driven motor (7), by which the locking latch (5; 5′) is movable.

5. The wheel hub according to claim 1, characterized in that the locking latch (5; 5′) can be biased by a spring (8), which brings the locking latch (5; 5′) into a locking position as its resting position.

6. The wheel hub according to claim 1, characterized in that the recess is designed as a circumferential groove (1′) on the thru-axle.

7. The wheel hub according to preceding claim 1, characterized in that the recess is formed by at least one pocket (1″), which is created by a radial wedge-shaped cutout on the outer circumference of the thru-axle.

8. The wheel hub according to claim 7, characterized in that a plurality of pockets (1″) is provided, which are spaced radially from each other around the outer circumference of the thru-axle, and the wedge shape of a respective cutout has a complementary shape to the part of the locking latch that fully contacts the pocket when engaged.

9. The wheel hub according to claim characterized in that the locking latch (5; 5′) is actuated by an eccentric cam (6), which is mounted on an output shaft of the motor (7).

10. A wheel with a wheel hub according to claim 1.

11. A vehicle with a wheel according to claim 10, further comprising a fork with two fork legs, wherein at least one end of a fork leg has a closed bore for passing through the thru-axle.
